(19) United States
(12) Patent Application Publication
(10) Pub. No.: US 2012/0103978 A1
(43) Pub. Date: May 3, 2012

(54) MICROWAVE CHEMICAL REACTOR

(75) Inventor: Iginio LONGO, Pisa (IT)

(73) Assignee: CNR CONSIGLIO NAZIONALE DELLE RICERCHE, Rome (IT)

(21) Appl. No.: 13/293,028

(22) Filed: Nov. 9, 2011

Related U.S. Application Data
(63) Continuation-in-part of application No. 11/722,723, filed on Jan. 30, 2008, now abandoned.

(30) Foreign Application Priority Data
Dec. 24, 2004 (IT) PI2004A000097
Dec. 14, 2005 (IB) PCT/IB2005/003782

(51) Int. Cl. H05B 6/64; B01J 19/26; B01J 19/08

(52) U.S. Cl. 219/756; 422/186; 422/186.3; 422/119

(57) ABSTRACT

Microwave heating apparatus for chemical-physical processes comprising a microwave source, operatively connected to an end of an antenna at a connector. The antenna is put in a reaction container where it irradiates with microwaves a reacting material. The antenna is coated with a sheath that avoids a direct contact with the reacting material, or is put into in a housing executed in the container. The housing, made of a material transparent to microwaves, can cross the reaction container for a part thereof, or for all its width. The arrangement of the antenna in the reacting material provides a quick and effective heating. Furthermore, it is possible to increase considerably the selectivity, the control and the efficiency of a chemical-physical processes to which the heating technique above described is applied. This allows also to provide a considerable energy saving with respect to apparatus of prior art.

This application is a continuation-in-part of U.S. application Ser. No. 11/722,723, filed Jan. 30, 2008, which is a 371 of International application number PCT/IB2005/003782, filed Dec. 14, 2005, which claims priority to Italian Application No. PI2004A000097, filed Dec. 24, 2004.

### FIELD OF THE INVENTION

The present invention relates to a microwave heating apparatus that can be used as heat source for chemical and/or physical processes.

Furthermore, the invention relates to a method that uses this apparatus for carrying out such processes.

### BACKGROUND OF THE INVENTION

As well known, many chemical processes have to be triggered by high temperature, and other processes are strongly accelerated by high temperature. Therefore, in many cases a reacting material is supplied by energy from a heat source. Traditionally, this is made through apparatus that transfer heat to the reacting material by conductivity or convection. However, such apparatus are often inefficient, since they not perform a uniform distribution of temperature in the reacting material or they require long time for bringing the reaction to a predetermined temperature.

In the last years, microwave apparatus are commonly used in research laboratories and in the industry. In this type of apparatus, a quick variation of the electromagnetic field that influences the material cause its direct heating and with a maximum efficiency with respect to traditional heating methods.

A microwave apparatus typically comprises an oven in which the reacting material is put and then irradiated with radio waves at high frequency. Microwaves are generated by a Magnetron that causes an electronic beam to oscillate at a very high frequency, thus creating microwaves, or more recently they are generated by solid state oscillating devices. These apparatus have relevant advantages with respect to traditional heat source. In fact, they are capable of providing an exceptionally quick heating of the reacting material and of quickly achieving higher temperatures than other conventionally used systems.

However, the technology of heating with microwave ovens has some drawbacks.

Firstly, reactors used for this type of technology have to be made of suitable materials, i.e. materials transparent to microwaves. The used microwave reactors are normally closed in containers with metal walls that are scarcely manageable and are accessible in a difficult way. Furthermore, it is not possible to use microwaves in case of reactions that take place at high pressures, since metal reactors are required with high thicknesses, and for these reactions they cannot be crossed by microwaves.

Other drawbacks are the high cost and the high energy consumption required by the microwave technology that strongly limits its diffusion on a large scale.

### SUMMARY OF THE INVENTION

It is therefore a first feature of the invention to provide a microwave heating apparatus for chemical-physical processes that provides a method for heating a reacting material that is more effective and practical with respect to the devices of prior art.

It is another feature of the invention to provide a microwave heating apparatus for chemical-physical processes that provides an energy saving and that is cheap with respect to apparatus of prior art.

It is also a feature of the invention to provide a microwave heating apparatus for chemical-physical processes for applying the microwave technology also in the field of reactions that take place in a condition of high pressure.

It is also a feature of the invention to provide a microwave heating apparatus for chemical-physical processes for activating chemical reactions in a homogeneous or heterogeneous phase, either continuous or pulsed.

These and other features are accomplished with one exemplary microwave heating apparatus for chemical-physical processes, according to the present invention, said apparatus comprising:
a microwave source,
a reaction container in which a reacting material is arranged,
means for transferring microwaves generated by the source to the reacting material, said means for transferring being arranged directly in the reaction container.

According to the invention, the reaction container has a housing coated with dielectric material transparent to microwaves suitable for receiving the means for transmission. The housing crosses the container for at least one part thereof. The microwave source and the means for transferring is arranged in a reaction station, and a means is provided for conveying the reacting material from a first position, upstream of the reaction station, to the reaction station, and then to a second station downstream of the reaction station. In the reaction station the means for transferring is arranged at least in part within the reaction container and can irradiate directly the reacting material.

Advantageously in the reaction station an actuation means can be provided for moving the means for transferring from a first position, outside of the housing, to a second position inside of the housing, such that in the second position the means for transferring is arranged at least in part within the reaction container and can irradiate directly the reacting material.

Preferably, the reaction container can be a reaction vessel in which the housing is integrated, and the means for conveying is arranged to move the reaction vessel from the first position, upstream of the reaction station, to the reaction station, in which the means for transferring is aligned with the housing of the reaction vessel and is in turn introduced in the housing by the actuation means, and then to the second station downstream of the reaction station.

In a possible embodiment of the invention, the reaction container is a reaction tube in which the housing is integrated to the reaction tube, and the means for conveying is arranged to cause the reaction material to flow in the reaction tube from the first position, upstream of the reaction station, to the reaction station in which the means for transferring is arranged in the housing of the reaction tube, and then to the second station downstream of the reaction station.

In particular, the housing can be integrated to the reaction tube at least in part transversally to the reaction tube.

In a possible preferred embodiment, a plurality of housings is arranged at least in part transversal to the reaction tube, and a plurality of means for transferring is provided arranged in the housings, wherein a control means is further provided to control the irradiation power in the reaction tube according to a desired temperature profile of the reaction material flowing in the reaction tube.

Preferably, the housing can be integrated to the reaction tube coaxially to the reaction tube.

Advantageously, the second station can comprise a nozzle, and the reaction material can be projected through the nozzle into a vacuum chamber where it can be deposited on a deposition substrate.

In an exemplary embodiment of the invention, the apparatus comprises also a means for emitting one form of energy selected from the group comprised of:
visible waves,
UV waves,
infrared waves,

or a combination thereof.

Advantageously, the reaction container can provide a coating layer made of a heat-insulating material.

In particular, the apparatus can comprise, furthermore, at least one sensor for measuring a process parameter, for example pressure or temperature, during the development of the reaction.

Advantageously, the apparatus can comprise also a means for mixing the reacting material, for example a mixer of the type with magnetic bar.

Preferably, the means for transferring the microwaves comprises at least one microwave antenna, for example of co-axial type or in a wave guide, which has at an end a connector for being operatively connected to the microwave source, and at the other end a microwave emitter suitable for irradiating the reacting material.

Advantageously, the antenna is coated with a closed sheath of inert material, for example PTFE, glass, ceramics etc., suitable for avoiding a direct contact with the reagents.

In a possible configuration of the invention, the means for transferring the microwaves comprises at least two antennas, which are excited in phase by the source in order to obtain a desired heating configuration. More in detail, the heating configuration is made exploiting the principle of interference of coherent electromagnetic waves emitted by each antenna.

In particular, the end of the antenna at which the transmission of microwaves is performed is of the dipolar type, or monopolar, and has a shape selected from the group comprised of:
a spiral,
coated with dielectric material,
with a radiating slit
with more radiating slits,
with a metal tip.

In particular, the co-axial microwave antenna comprises:
an inner conductor,
a dielectric that coats the inner conductor for all its length,
an outer conductor that covers coaxially the dielectric except from an end portion.

Advantageously, the microwave antenna can furthermore provide:
a choke mounted out of the outer conductor near the end portion, the above described choke comprising a co-axial conductive portion of diameter higher than the outer conductor.

Advantageously, the reaction container has a housing in communication with the outside that crosses it at least for a part thereof. The housing is suitable for receiving, in use, the above described means for transmission.

In particular, the housing is of dielectric material transparent to microwaves and prevents from a direct contact of the transmission means with the reacting material.

Advantageously, the reaction container has at least one opening through which it is possible to approach the reacting material for arranging means for measurement, for example of temperature and pressure.

In an exemplary embodiment of the invention, the reaction container comprises:
a reaction chamber having the walls made of material for insulating from the heat flux generated by microwaves,
an external jacket of a metal material of determined thickness capable of resisting to high pressures.

Advantageously, means are provided for modulating the frequency of microwaves to adjust the power transferred to the reacting material responsive to the type of process.

The microwave apparatus, as above described, increases considerably the control, the speed, the selectivity and the stability of the processes. Furthermore, the power emitted by the antenna is adsorbed by the reacting material allowing the operator to work in safety conditions with respect to the emissions of electromagnetic waves. In case of use of high heating power, to avoid residue emissions out of the reaction container, the latter has a shielding layer that is opaque to microwaves, for example, a film, a varnish, or a metal braiding.

According to another aspect of the invention, a method for heating with microwaves a reacting material in chemical-physical processes comprises the steps of:

generating microwaves by a microwave source of power,
providing in a reaction station a means for transferring the microwaves generated by the source to said reacting material,
wherein said reaction container has a housing coated with dielectric material transparent to microwaves suitable for receiving said means for transmission, said housing crossing said container for at least one part thereof,
wherein said microwave source and said means for transferring is arranged in a reaction station
means for conveying said reacting material from a first position, upstream of said reaction station, to said reaction station, and then to a second station downstream of said reaction station,
wherein in said reaction station an actuation means is provided for moving said means for transferring from a first position, outside of said housing, to a second position inside of said housing, such that in said second position said means for transferring is arranged at least in part within said reaction container and can irradiate directly said reacting material that is arranged directly within said reaction container

### BRIEF DESCRIPTION OF THE DRAWINGS

The invention will be now shown with the following description of an exemplary embodiment thereof, exemplifying but not limitative, with reference to the attached drawings wherein:

FIG. 1 shows diagrammatically an elevational front view of a microwave heating apparatus for chemical-physical processes, according to the invention,

FIG. 2 shows diagrammatically an elevational front view of a first exemplary embodiment of a reaction container that can be used in the apparatus of FIG. 1,

FIGS. 5 and 6 show two different exemplary embodiments of microwave antenna that can be used in the apparatus of FIG. 1 in operative conditions,

FIGS. from 7A to 7F show diagrammatically elevational side views of some exemplary embodiments of co-axial antennas that can be used in the apparatus of FIG. 1.

FIG. 8 shows a reactor according to the invention with a housing for introducing the antenna in the vial without contact with the content of the vial;

FIG. 9 shows a microwave-assisted chemistry diagrammatical apparatus, using the reaction vial of

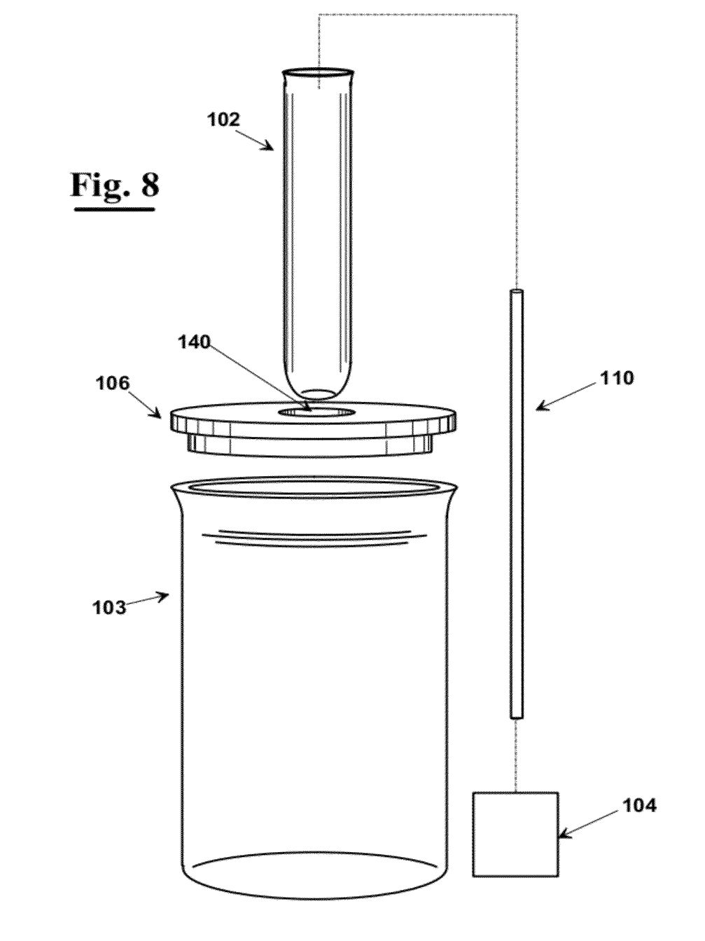

FIG. 8 and a conveyor belt for carrying the reaction vial through successive treatment stations;

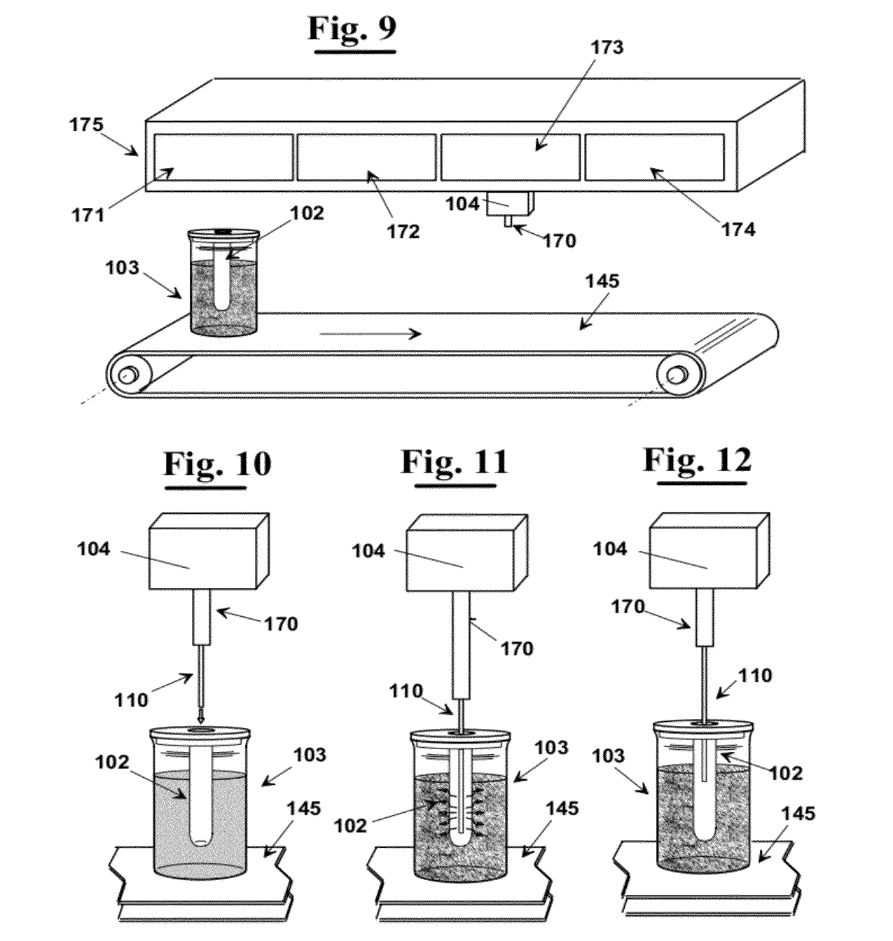

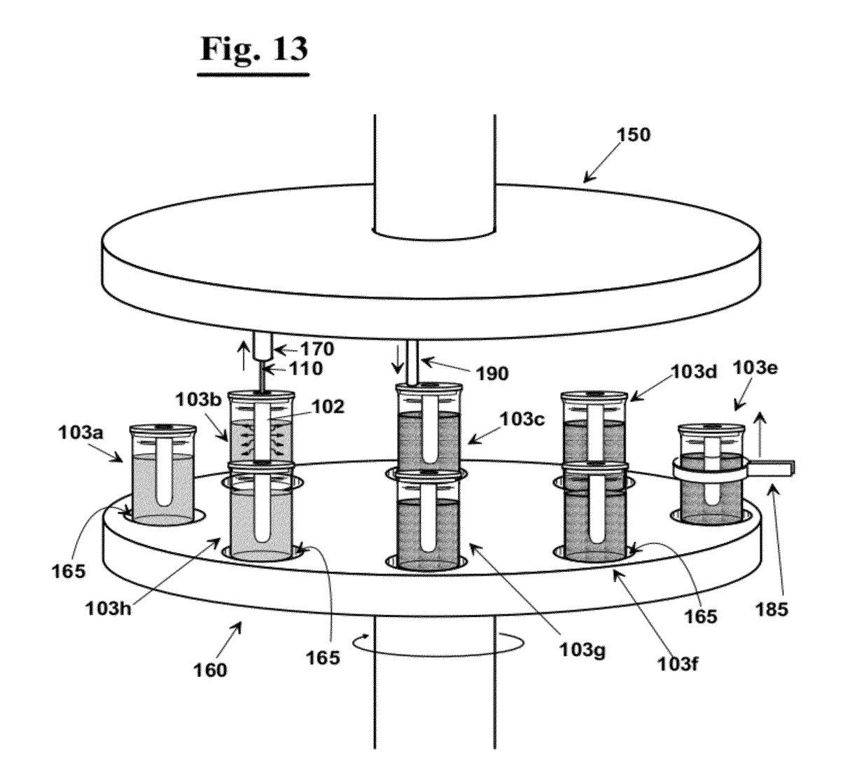

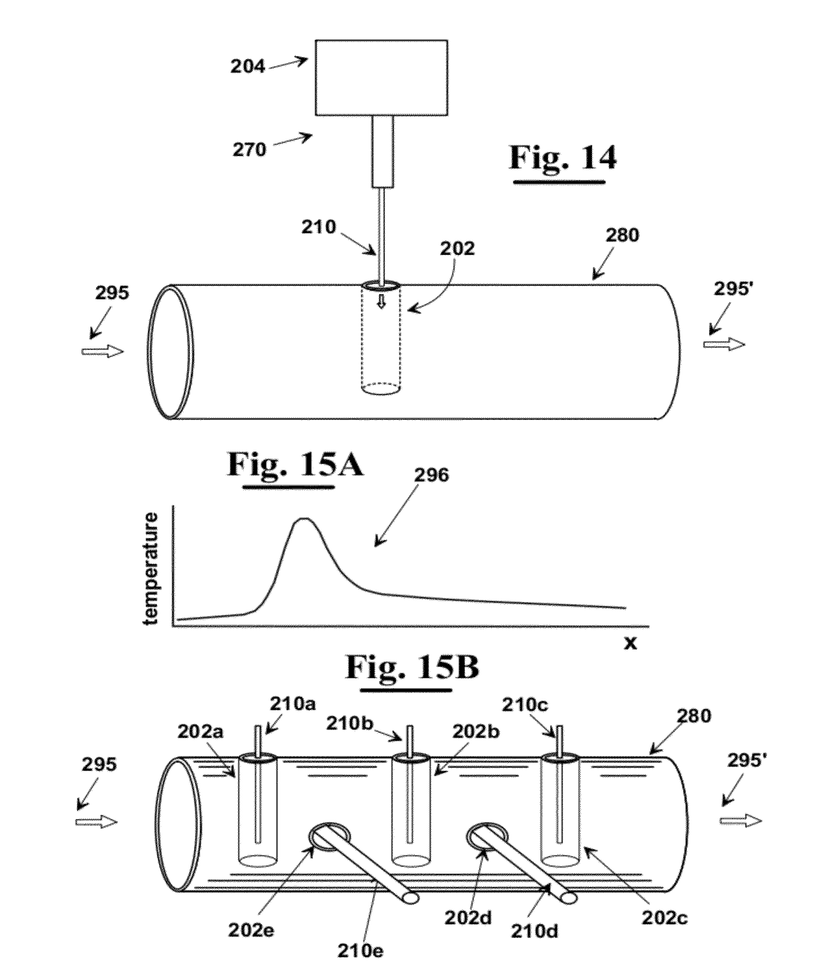

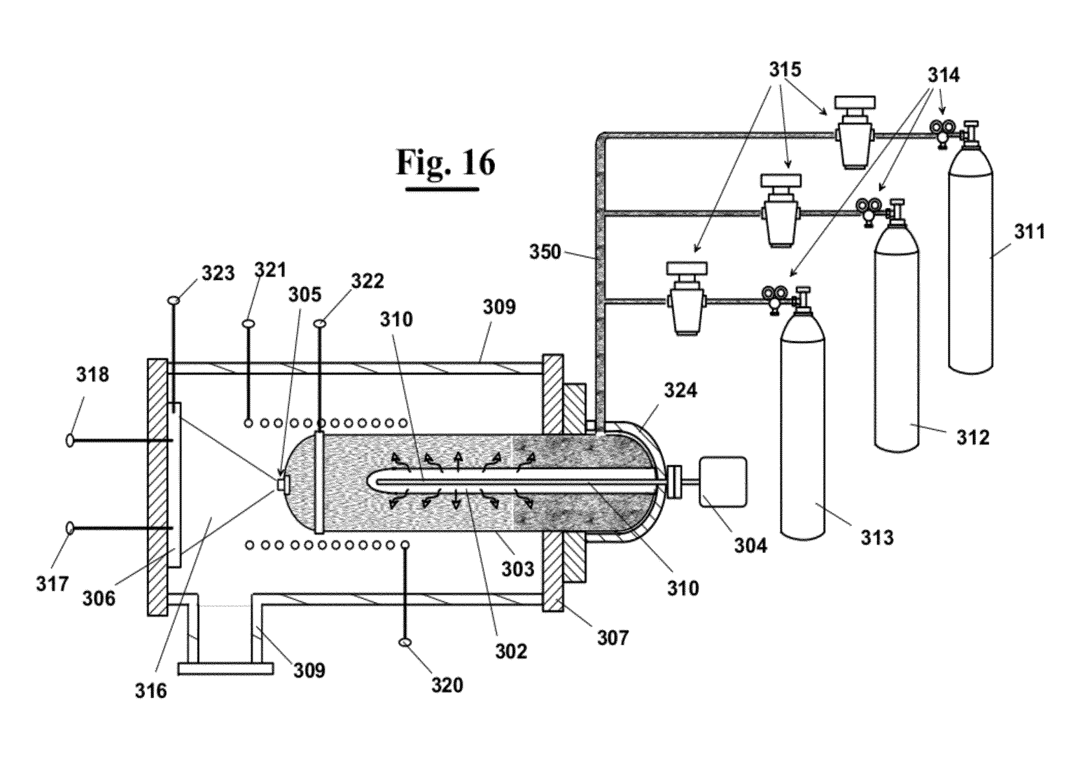

FIGS. 10-12 show three successive microwave reaction step with an apparatus like that of FIG. 9 and a reaction vial of FIG. 8.

FIG. 13 shows a carousel, alternative to the conveyor belt of FIG. 9, for carrying the reaction vial through successive treatment stations

FIG. 14 shows a reaction tube with a housing for introducing the antenna in the tube without contact with the content of the reaction tube;

FIG. 15 shows a reaction tube similar to that of FIG. 14, with a plurality of housings for introducing antennas in the tube;

FIG. 16 shows a microwave reactor according to the invention arranged to deposit on a substrate a thin film of desired chemical composition.

### DESCRIPTION OF THE PREFERRED EMBODIMENT

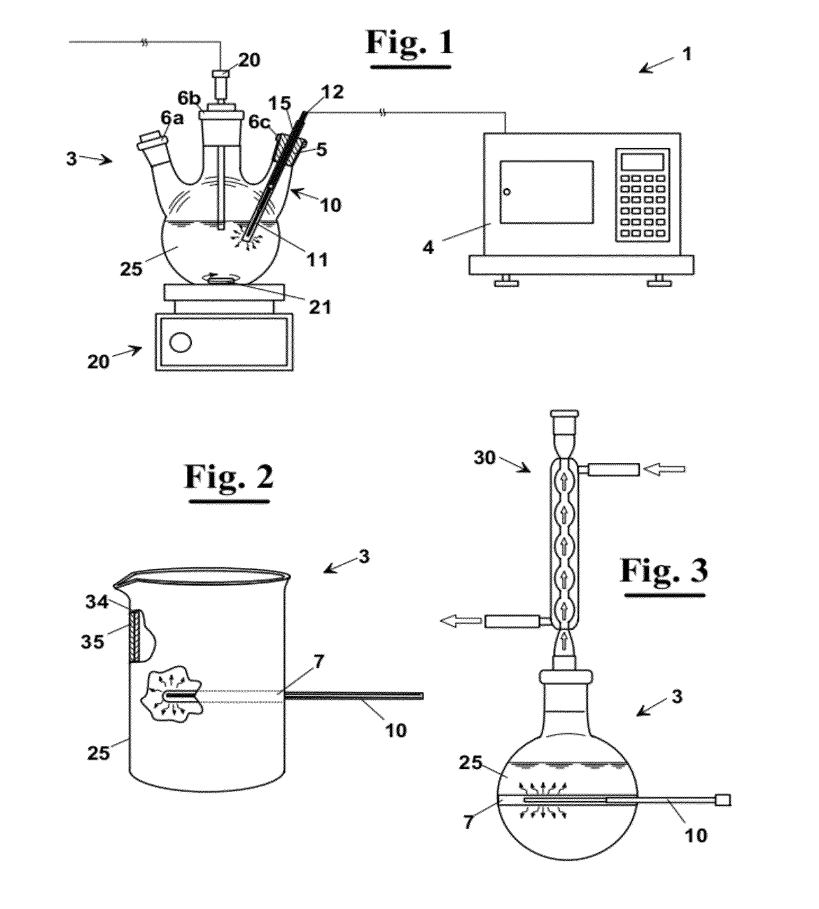

With reference to FIG. 1, a microwave heating apparatus 1 for chemical-physical processes, according to the present invention, comprises a microwave source 4, for example a magnetron or a klystron or a solid state oscillator (FET transistor), operatively connected to an end of an antenna 10 at a connector 12. Antenna 10 is put into a reaction container 3 where it irradiates with microwaves a reacting material 25 at its end 11. In particular, antenna can be coated with a sheath 15 that prevents from a direct contact with the reacting material 25 (FIG. 1), or alternatively, can be put into in a housing 7 made in the container 3. Housing 7, which is made of a material transparent to microwaves, can cross reaction container 3 for a part thereof (FIG. 2), or for all its width (FIG. 3).

The arrangement of antenna 10 in the reacting material 25 provides a quick and effective heating. Furthermore, it is possible to increase considerably the selectivity, the control and the efficiency of the chemical-physical processes to which the heating technique above described is applied. This allows also to provide a considerable energy saving with respect to apparatus of prior art.

Reaction container 3 can be a common container for research laboratories, for example a sphere with three apertures 6a, 6b and 6c (FIG. 1), or alternatively, a becker (FIG. 2). Reaction container 3 can be of glass or other inert material, which can be coated with a inner layer of PTFE, alumina, or other material resistant at high temperature and pressures.

In case it is necessary to use high power, it is suitable to have reaction container 3 coated with a shielding layer 35, which is next to the external walls 34 of the container 3 (FIG. 2) and opaque to microwaves. This avoids a propagation of microwaves out of the container 3. The shielding layer can be made for example by a film, a varnish, or a metal braiding that reflect microwaves in the reacting material 25.

This allows to an operator to work in safety conditions.

For mixing effectively the reacting material 25, in reaction container 3 a magnetic bar 21 can be put that is wheeled in the reacting material 25 by a mixer 20.

In case of a sphere 3 the apertures 6a, 6b and 6c can be used for arranging sensors 20 that monitor continuously some process parameters, for example the pressure and/or the temperature (FIG. 1). Therefore, the course of the process can be measured instantly and, for example, the frequency and the power of microwaves emitted by antenna 10 can be changed correspondingly.

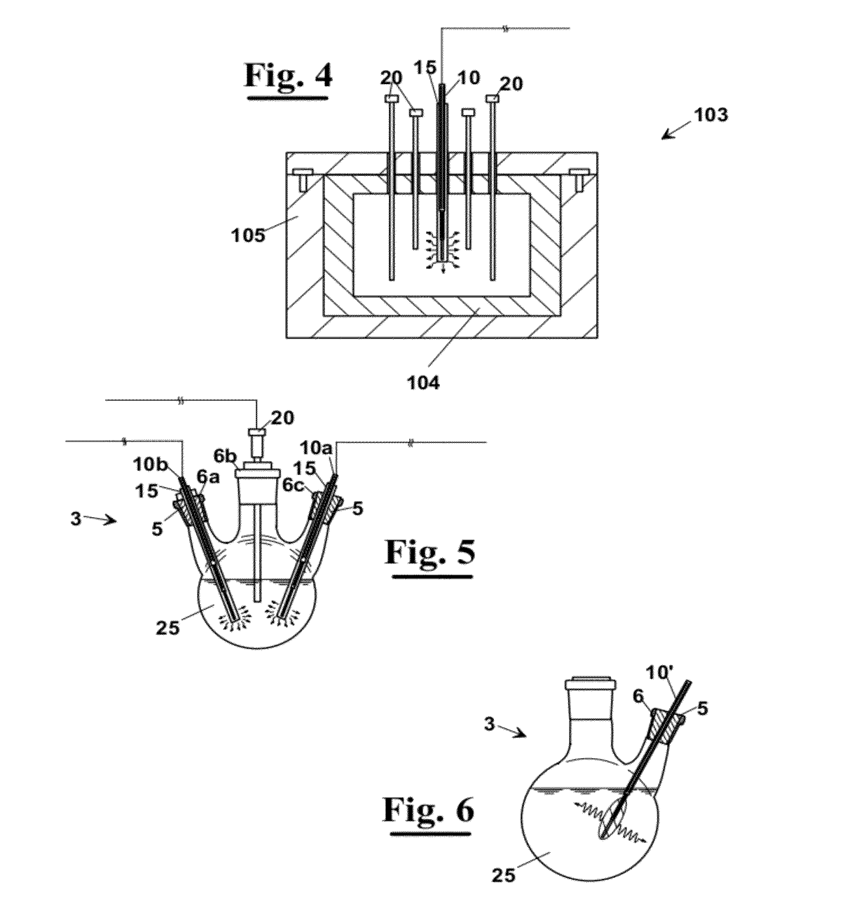

According to an exemplary embodiment of the invention, it is possible to irradiate the reacting material 25 contained in reaction container 3 through a plurality of antennas, for example two antennas 10a and 10b (FIG. 5), which can be excited in phase by the same source. In this way, it is possible to provide a heating configuration with a geometry that is responsive to different operative reasons required by a specific process, exploiting the phenomenon of the interference of coherent electromagnetic waves. The heating apparatus according to the invention is, furthermore, highly flexible and implemented to many types of different processes. For example, in case of reactions exothermic it is possible to associate a reflux coolant of Allhin type 30 (FIG. 3) to a reaction container 3 in which antenna 10 works. In the case, instead, of processes that occur at high pressures a reaction container 103 (FIG. 5) can be provided having a inner jacket 104 of coating thermo-insulating material, for example Teflon, contained in a jacket of a metal material 105 of suitable thickness. In this way it is possible to use the heating technique by means of microwaves for carrying out processes that are performed at high pressures.

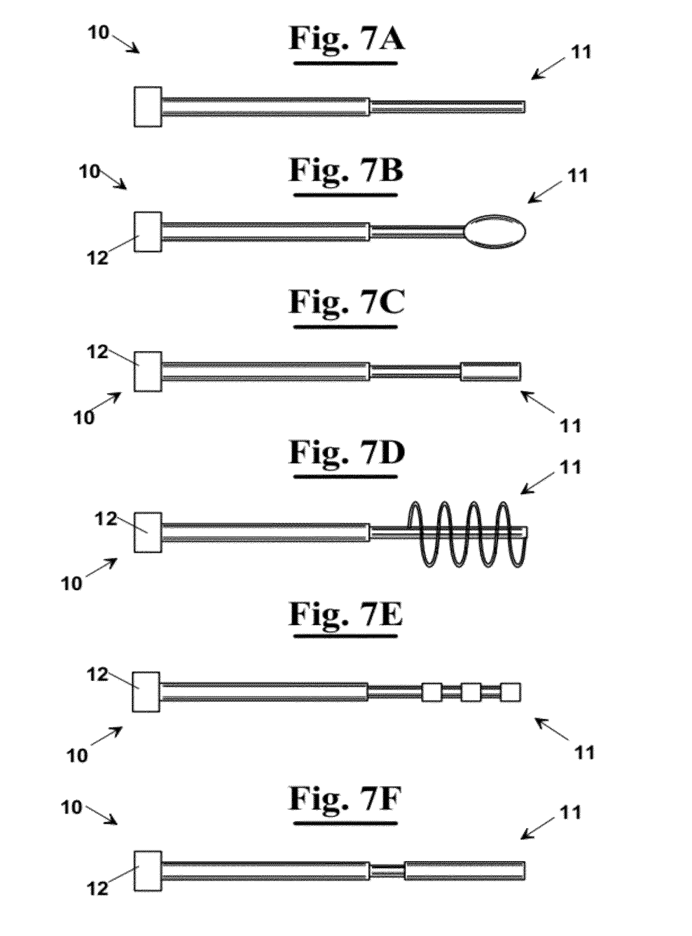

In FIG. 6 the possibility is diagrammatically shown of using as heating means an antenna 10′ capable of emitting, in addition to microwaves, visible light waves, UV waves, infrared waves, or a combination thereof, for particular types of processes.

In FIGS. from 7A to 7F some possible exemplary embodiments are shown of an antenna 10 that can be used as microwave emitter. In particular, co-axial antenna 10 can be of dipolar type (FIGS. 7A-7D) and can provide at the microwave emitting end a configuration with a dielectric-tip (FIG. 7A), a sphere tip (FIG. 7B), a metal tip (FIG. 7C), a coil-tip (FIG. 7D), a slotted tip (FIG. 7E), multislotted tip (FIG. 7F). Alternatively, antenna 10 can be of the monopolar type and can be carried out similar to the above described exemplary embodiments. Furthermore, antenna 10 can be provided with a trap or “choke” suitable for preventing the emitted microwaves to spread back towards the source.

With reference to FIG. 8, a co-axial antenna 110 is provided connected to a microwave source 104 by a cable not shown. A housing 102 of dielectric material is provided, such as glass or ceramic. The housing 102 is introduced through a hole 140 in a plug 106 and welded or sealed to it, in order to be arranged co-axial to a reaction vial 103, for example made of glass.

The housing 102 is transparent to microwaves, and permits passage of the microwaves into reaction vial 103, without contact between antenna 110 and any liquid or sample present in the vial, permitting re-usage of the antenna for further treatments in similar vials without the need of cleaning it or replacing it.

Of course, the reaction vial, the housing, the plug can be connected and shaped in any desired way alternative to that of FIG. 8, in order to achieve the same effects.

With reference to FIG. 9, a microwave-assisted chemistry can be carried out using a conveyor belt 145 on which reaction vial 103.

The reactor vials on the belt are submitted to a number of automatic and programmable operations under a plurality of stations 171-174 of a treatment unit 175, that is shown only diagrammatically. Under stations 171-174 vial 103 may be added with samples, carrier fluids, chemicals, as well as fluids or treated samples can be removed. At least one of stations 171-174 can provide a microwave source 104.

With reference to FIGS. 10-12, the reactor vial is positioned by conveyor belt 145 under the microwave treatment station, for example station 173. An actuator 170 is provided for moving antenna 110 into housing 102 (FIG. 10). Then, once the antenna is in the glass well 102 to activate the reaction, microwave source 104 supplies power to co-axial antenna 110 (FIG. 11), and eventually antenna 110 is withdrawn from housing 102, so that conveyor belt can move reaction vial 103 forward.

The conveyor 145 can transport a large number of vials enabling automatic activation of chemical reactions at various microwave power level, at different temperatures and using a selected quantity of reactants. A magnetic stirring bar can be provided, not shown.

With reference to FIG. 13, a plurality of reactor vials 103a-103h can be carried also by a carousel 160, and from the above, a platform 150 can be provided where antenna 110 can be actuated to enter the housing 102 of a vial in a determined station, in the example vial 103b. In the other stations, the other vials can be added with fluids, reactants, samples, or fluids removed, or other treatments applied. For example, a needle 190 can enter vial 103c, to add or extract material from it. A robotic arm 185 can be provided in one station to load/unload vials onto/away from the carousel, for example on vial 103e.

With reference to FIG. 14, a continuous flow microwave reactor 280 can be provided, in which, transversally, a housing or well 202 can be provided in which co-axial antenna 210 can be introduced by an actuator 270, connected to microwave source 204 by a cable not shown. The housing 202 can be advantageously of dielectric material, such as glass or ceramic. When a fluid 295 enters reactor tube 280, it crosses a region around housing 202, where the microwaves generated by antenna 210 heat the fluid and change the temperature and chemical-physical status of exiting fluid 295.

If a desired temperature profile 296 has to be achieved in the fluid, like that shown, for example, in

FIG. 15A, a plurality of antennas 210a-210e can be arranged, as depicted in FIG. 15B, in respective housings 202a-202e of reactor tube 280. In order to adjust the power and achieve the desired temperature profile 296, the coaxial antennas 210a-210e can be partially withdraw or fully introduced in housings 202a-202e, and their microwave power adjusted accordingly. Not shown temperature sensors, flow rate sensors, and pressure sensors can be provided, in order to achieve the desired adjustment on the temperature profile.

Advantageously, as shown in FIG. 15B, adjacent housings can be provided orthogonal to each other, i.e. housings 202a, 202b, 202c are parallel to each other, and housings 202d, 202e are parallel to each other, but housings 202d, 202e are orthogonal and alternated to housings 202a, 202b, 202c. In this way, there is no relevant interference occurs between the microwaves irradiated by two adjacent antennas.

In another exemplary embodiment, shown in FIG. 16, a microwave reactor according to the invention can be mounted and used in an advantageous way to deposit on a substrate a thin film of desired chemical composition, by a process known as plasma-assisted chemical vapor deposition. The method is of interest of the electronic industry for making semiconductor substrates, sensors, catalysers, synthetic diamond, graphene and many other material nano or micro-composite materials.

The arrangement described in FIG. 16 provides a co-axial antenna 310, a microwave source, a cable (not shown) for connection to the microwave source and said source like the examples described above (not shown). A housing 302 of dielectric material, such as glass or ceramic. The housing 302 is welded to a co-axial reactor chamber 303, for example of glass, equipped with a tube 350 for inlet of a gas or vapour and of a nozzle ejector 305.

From nozzle ejector 305 a jet 316 exits of atomic or molecular species excited by the microwaves field emitted by antenna 310 and directed towards substrate 306, which can be of crystal or amorphous material. The co-axial reactor 303 is held by a metal plate 307 equipped with seals that can keep a high vacuum (not shown). The microwaves reactor 303 is contained in a chamber 308, for example cylindrical, of glass or other material compatible with operations under high vacuum, having an outlet 309 for connection to a high speed pumping system, not shown. In this way, in chamber 308 conditions can be achieved of propagation of atomic or molecular species without that they subject to deviations for hits with residue gas particles.

Chamber 308 is held at one end by a plate 307 and at the other end by a plate 310, with high vacuum sealing means, not shown. The plate 310 holds in the chamber 308 the substrate 306. At inlet 304 of reactor 303 the gas or vapour coming from pressurized containers, for example indicated with 311, 312, 313 reach valves 314 and pressure reduction systems 315 for controlling the flow.

The microwave field generated by antenna 310 crosses the gas or vapour in reactor 303 and excites it, with the production of ions, radicals and atomic or molecular species at high production energy level. Directional jet 16, reaches substrate 6 and coats it with a layer whose thickness increases versus time.

The deposition process may provide that substrate 306 is kept heated by a heater, for example electric, operated by conductors 317 and 318. At least one temperature sensor (not shown) can be provided to control the temperature of the substrate during the process to maintain it at a desired temperature.

A magnetic axial field can be provided produced by a winding 319 in which an electric current can be applied through ends 320 and 321, in order to focus the atomic or molecular species having electric charge.

Electrodes 322 and 323 can be arranged in reactor 303 respectively near nozzle 305 and near substrate 6, to provide an electric field parallel to the desired trajectories of the particles in order to boost jet 16, accelerating the particles in a selective way concerning the species having electric charge, increasing the capacity for controlling the process.

For example, the reactor can be used for depositing a layer of nanocrystal, on a wafer of silicon of some cms of diameter brought to the temperature of about 800C. In this case a flow of methane and hydrogen can be used contained for example in containers 312 and 313. The gaseous mixture, when crossing the reactor 3 with a predetermined flow rate, is excited by antenna 310, for example up to a power of about 1 kW at 2450 MHz. In this way, the Carbon atoms produced by molecular dissociation, reach the substrate and deposit on creating a film of nano-crystal diamond.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

What is claimed is:

1. A microwave heating apparatus for chemical-physical processes, comprising:
a microwave source;
a reaction container in which a reacting material is arranged;
means for transferring the microwaves generated by the source to said reacting material, wherein said reaction container has a housing of dielectric material transparent to microwaves suitable for receiving said means for transmission, said housing crossing said container for at least one part thereof;
wherein said microwave source and said means for transferring are arranged in a reaction station;
means for conveying said reacting material from a first position, upstream of said reaction station, to said reaction station, and then to a second station downstream of said reaction station;
wherein in said reaction station said means for transferring is arranged at least in part within said reaction container and can irradiate directly said reacting material.

2. An apparatus according to claim 1, wherein in said reaction station an actuation means is provided for moving said means for transferring from a first position, outside of said housing, to a second position inside of said housing, such that in said second position said means for transferring is arranged at least in part within said reaction container and can irradiate directly said reacting material.

3. An apparatus according to claim 2, wherein said reaction container is a reaction vessel in which said housing is integrated, and said means for conveying is arranged to move said reaction vessel from said first position, upstream of said reaction station, to said reaction station, in which said means for transferring is aligned with said housing of said reaction vessel and is in turn introduced in said housing by said actuation means, and then to said second station downstream of said reaction station.

4. An apparatus according to claim 1, wherein said reaction container is a reaction tube in which said housing is integrated to said reaction tube, and said means for conveying is arranged to cause said reaction material to flow in said reaction tube from said first position, upstream of said reaction station, to said reaction station in which said means for transferring is arranged in said housing of said reaction tube, and then to said second station downstream of said reaction station.

5. An apparatus according to claim 4, wherein said housing is integrated to said reaction tube at least in part transversally to said reaction tube.

6. An apparatus according to claim 4, wherein a plurality of housings is arranged at least in part transversal to said reaction tube, and a plurality of means for transferring is provided arranged in said housings, wherein a control means is further provided to control the irradiation power in said reaction tube according to a desired temperature profile of said reaction material flowing in said reaction tube.

7. An apparatus according to claim 4, wherein said housing is integrated to said reaction tube coaxially to said reaction tube.

8. An apparatus according to claim 4, wherein said second station comprises a nozzle out of which said reaction material can be projected into a vacuum chamber where it can be deposited on a deposition substrate.

9. An apparatus according to claim 1, wherein said reaction container provides a coating layer of heat-insulating material.

10. An apparatus according to claim 1, wherein said reaction container has a shielding layer opaque to said microwaves suitable for avoiding the propagation out of it.

11. An apparatus according to claim 1, comprising furthermore means for irradiating in said reacting material one further form of energy selected from the group consisting of visible waves, UV waves, and infrared waves, or a combination thereof.

12. An apparatus according to claim 1, further comprising at least one sensor for measuring a process parameter during the development of the reaction.

13. An apparatus according to claim 1, further comprising a means for mixing the reacting material.

14. An apparatus according to claim 1, wherein said means for transferring comprises at least one antenna which has at an end a connector that connects operatively said antenna to said microwave source, and at the other end a microwave emitter suitable for irradiating said reacting material.

15. An apparatus according to claim 7, wherein said antenna is coated with a closed sheath of inert material suitable for avoiding the direct contact with said reacting material.

16. An apparatus according to claim 1, wherein said means for transferring comprises at least two antennas, which are excited in phase from said source in order to obtain a desired heating configuration, by exploiting the principle of interference of the coherent electromagnetic waves emitted by each antenna.

17. An apparatus according to claim 1, wherein said end of said antenna at which the transmission of microwaves is performed is of the dipolar type, or monopolar type, and has a shape selected from the group consisting of a spiral, coated with dielectric material, with a radiating slit, with more radiating slits, with metal tip.

18. An apparatus according to claim 1, wherein said antenna is of co-axial type and comprises:
an inner conductor;
a dielectric that coats said inner conductor for all its length; and
an outer conductor that covers coaxially said dielectric except from an end portion.

19. An apparatus according to claim 11, wherein said antenna further comprises a choke mounted out of said outer conductor near said end portion, said choke comprising a co-axial conductive portion of diameter higher than said outer conductor.

20. An apparatus according to claim 1, wherein said reaction container comprises:
a reaction chamber having the walls made of a material for insulating from the heat flux generated by microwaves; and
an external jacket of a metal material of determined thickness capable of resisting to high pressures.

21. An apparatus according to claim 1, wherein means are provided for modulating the frequency of said microwaves to adjust the power transferred to said reacting material.

22. A method for heating with microwaves comprising the step of:
generating microwaves by a microwave source of power; providing in a reaction station a means for transferring the microwaves generated by the source to said reacting material;
wherein said reaction container has a housing of dielectric material transparent to microwaves suitable for receiving said means for transmission, said housing crossing said container for at least one part thereof;
wherein said microwave source and said means for transferring is arranged in a reaction station means for conveying said reacting material from a first position, upstream of said reaction station, to said reaction station, and then to a second station downstream of said reaction station;
wherein in said reaction station an actuation means is provided for moving said means for transferring from a first position, outside of said housing, to a second position inside of said housing, such that in said second position said means for transferring is arranged at least in part within said reaction container and can irradiate directly said reacting material that is arranged directly within said reaction container.
